(19) United States
(12) Patent Application Publication
(10) Pub. No.: US 2025/0276890 A1
(43) Pub. Date: Sep. 4, 2025

(54) RIDING SHEATH AND METHOD FOR MOUNTING SUCH A SHEATH

(71) Applicant: GROUPE VOLTAIRE, BIDART (FR)

(72) Inventors: Brice GOGUET, ARBONNE (FR); Kim GELLIDA, BIDART (FR); Sarah MARCEL, Anglet (FR)

(21) Appl. No.: 19/064,941

(22) Filed: Feb. 27, 2025

(30) Foreign Application Priority Data
Mar. 3, 2024 (FR) 2402125

(51) Int. Cl. B68C 1/12

(52) U.S. Cl. CPC B68C 1/12

(57) ABSTRACT

A riding sheath, configured to be placed on a body of a horse, including a main member configured to girdle the body of the horse; a secondary member, independent of the main member, configured to be positioned on the chest of the horse, the secondary member being removably connected mechanically to the main member by at least one mechanical connecting member, the main member and the secondary member each including at least one extensible material; and at least one attachment member configured to cooperate with a connecting member of a riding saddle so as to attach the riding saddle to the riding sheath. The attachment member being connected in a fixed manner to the main member.

### TECHNICAL FIELD

The present invention relates to the field of riding accessories and is aimed in particular at the riding accessories configured to be positioned on a horse.

In a known way, with reference to FIG. 1, a riding saddle S is placed on the back of a horse CH to form a seat for a rider. The riding saddle S, referred to as “saddle S”, is held in position by means of a riding girth A1, referred to as “girth A1”, extending under the barrel of the horse CH. The saddle S and the girth A1 are attached together by a plurality of girth straps forming a plurality of buckle/belt connections that may be opened and closed manually by a user.

To protect the horse CH from friction from the saddle S, it is known to place a pad A2 between the back of the horse CH and the saddle S. The pad A2, generally made of quilted fabric, also absorbs sweat from the horse CH and cushions the weight of the rider. As is well known, the pad A2 comprises two side loops PL to receive the girth A1 and prevent the pad A2 from slipping relative to the saddle S.

In equestrian circles, it is also known to use various riding accessories to ensure the comfort of the horse CH and to avoid any risk of untimely movement of the saddle S when the horse CH is moving, for example.

For this purpose, a cushioning A3 is known, which generally takes the form of a cushion shaped to fit the back of the horse and is placed between the pad A2 and the saddle S. The cushioning A3 allows to cushion the weight of the rider and distributes the pressure of the saddle S over the back of the horse CH.

Also known is a breast collar A4 positioned on the chest of the horse CH and connected, on the one hand, to the girth A1, under the barrel of the horse CH, and, on the other hand, to the saddle S, at the back of the neck of the horse CH. Such a connection is generally made by means of three straps that may be opened and closed manually by a user. The straps allow the length of the breast collar A4 to be adapted to the morphology and to the size of the horse CH. The breast collar A4 allows to ensure that the saddle S is correctly positioned on the back of the horse CH and that the latter does not have the risk to slip backwards, particularly when the horse CH is in motion, which could hinder it.

However, all these riding accessories (girth A1, pad A2, cushioning A3 and breast collar A4) have a number of disadvantages.

The girth A1 and the breast collar A4 are generally made of leather so that they may be connected to the saddle S for an effective hold. However, these accessories may lead to pressure points on the horse, which may cause a discomfort or even a risk of injury if they are incorrectly positioned. A badly positioned girth A1 or breast collar A4 may also hinder the horse CH in its movements.

Similarly, it is important that the pad A2 is positioned precisely to avoid hindering or even injuring the horse, particularly around the withers. It is also generally necessary to adapt the shape and the size of the pad A2 to the saddle S used, to ensure that there is no contact between the horse and the saddle S. If a rider uses different saddles S, for example for various equestrian activities, it is generally necessary to have a dedicated pad A2 for each type of saddle S, which is impractical.

Moreover, all the accessories A1, A2, A3, A4 have to be positioned precisely in relation to each other and are connected together by a large number of attachments, which makes preparing the horse a complex task. Moreover, each riding accessory A1, A2, A3, A4 has to be placed individually and in a precise order to the horse CH, which is time-consuming.

To overcome some of these disadvantages, the document FR2984296 describes a band allowing to attach a saddle to the back of a horse. The band, which is made of fabric, is placed on the periphery of the body of the horse and allows to fulfil both the function of the pad and that of the girth. The band may also be extended over the chest of the horse to prevent it from slipping backwards. However, the band is very wide under the barrel of the horse to avoid the pressure points, which does not allow the horse to move easily. Moreover, when the band also extends over the chest of the horse, in order to provide an effective support over a sufficient surface area, the band also extends over the shoulders of the horse and in particular over the shoulder tips of the horse, which may hinder some of its movements. Moreover, such a device, which covers both the body of the horse and its chest, has to be specifically adapted to the morphology of the horse to avoid causing discomfort, which means offering a wide range of products to suit different sizes of horse. This complicates the manufacturing method and may lengthen production times.

The invention thus aims to eliminate at least some of these disadvantages by providing a device for allowing the attachment of a saddle to a horse that is simple, practical and quick to install. The invention is aimed in particular at a device that may be adapted to different sizes of horse while respecting the morphology and the comfort of the horse.

Incidentally, we know from the document WO2019162527A1 a riding saddle wherein a harness extending in front of the chest of the horse is connected to a saddle pad liner mounted on the back of the horse.

### PRESENTATION OF THE INVENTION

The invention relates to a riding sheath, configured to be placed on a body of a horse, comprising:
a main member configured to girdle the body of the horse,
a secondary member, independent of the main member, configured to be positioned on the chest of the horse, the secondary member being connected mechanically, in a removable manner, to the main member by at least one mechanical connecting member, the secondary member being configured to hold the main member in a predetermined position on the body of the horse, the main member and the secondary member each comprising at least one extensible material to adapt to the body of the horse,
at least one attachment member configured to cooperate with a connecting member of a riding saddle so as to attach the riding saddle to the riding sheath, the attachment member being connected in a fixed manner to the main member.

The riding sheath according to the invention advantageously allows the installation of a single riding accessory on the back of a horse to allow a saddle to be attached while ensuring that there is no risk of the saddle moving unexpectedly and that the horse is not hindered or injured. The riding sheath allows to eliminate the need to install a pad, a breast collar and a girth, as was the case in the prior art. More specifically, the main member allows to replace the riding pad and the girth, and the secondary member allows to ensure that the main member and therefore the saddle may not slip backwards over the back of the horse, thereby allowing to eliminate the need for the additional installation of a breast collar. In other words, the riding sheath according to the invention allows to simplify the preparation of a horse, limiting the amount of equipment to be handled and saving a lot of time.

The main member and the secondary member, each comprising an extensible material, allow to form a riding sheath capable of adapting to the morphology of the horse, thereby allowing to ensure the comfort of the horse. There is therefore no risk of the user being hindered by the various accessories, as was the case in the prior art.

Thanks to the secondary member being independent of the main member, the position of the secondary member may advantageously be adapted in relation to the position of the main member on the horse. In other words, the riding sheath may be positioned to suit the morphology of the horse. Compared with the prior art pads, the riding sheath according to the invention thus offers greater flexibility, as it may be adapted to different horse morphologies and different types of saddle.

In one embodiment, the main member is made in one-part. This allows to limit the mechanical connections, which limits the pressure points on the horse and avoids any risk of injury. Limiting the number of mechanical connections, for example of the buckle/belt type, also saves a great deal of time.

In one embodiment, the connecting member is adjustable. The advantage of this is that the sheath may be adapted quickly and easily to different horse sizes and morphologies, allowing a limited range of riding sheath sizes to be manufactured, unlike the band of the prior art, which had to be precisely adapted to the horse to avoid causing discomfort, thus necessitating the manufacture of an extensive range, or even a made-to-measure range. The riding sheath also helps to keep production costs down.

Preferably, the main member comprises at least one indentation to release an arm of the horse. In other words, the main member is advantageously not in contact with the arm of the horse. The term “arm” refers to the humerus, the area directly above the front leg of the horse. Even more preferably, the indentation in the main member allows to free up the biceps brachii and the triceps brachii of the horse, giving it a particularly high degree of ease of movement. The tip of the shoulder is also advantageously released. Such an indentation allows the riding sheath to be adapted to the morphology of the horse while limiting the risk of discomfort. In particular, when the horse is in motion, the release of the shoulder tip, the biceps brachii and the triceps brachii allows considerable freedom of movement. The riding sheath therefore has no impact on the performance of the horse, unlike the band of the prior art.

Preferably, the main member comprises two symmetrical indentations to release in an equivalent manner the two arms of the horse, which allows a movement freedom for the two forelegs of the horse. Preferably, each indentation allows the shoulder tip, the biceps brachii and the triceps brachii to be released on either side of the horse. This means that the main member has no impact on the movements and the performance of the horse.

Preferably, the secondary member comprises at least one indentation to release a shoulder tip of the horse. In other words, the riding sheath is advantageously not in contact with the shoulder tip of the horse, giving him total freedom of movement. “Shoulder tip” refers to the joint at the front of the horse between the arm and the blade bone of the horse.

Even more preferably, the secondary member comprises two symmetrical indentations to release the shoulder tips of the horse in an equivalent manner. The advantage of this is that it allows the forelegs of the horse to move more freely and avoids any risk of hindering the locomotion of the horse.

In a preferred embodiment, the main member is made at least in part from a fabric web or from neoprene. Such a material may advantageously adapt to the morphology and to the movements of the horse. In other words, a material of this type offers a considerable flexibility, limiting both pressure points and discomfort for the horse. A main member made from an extensible fabric web or from a neoprene material also saves weight by eliminating the need to install additional horse tack, often made in leather. A fabric web or a neoprene material is also advantageously machine washable, unlike the riding accessories of the prior art, for example the riding girth or the breast collar, which are generally made of leather. In one embodiment, the fabric web is Lycra®, which has elastic, quick-drying and moisture-repellent properties.

According to a preferred aspect of the invention, the main member comprising a dorsal portion, configured to be in contact with the back of the horse and comprising a main structure, and a ventral portion, configured to be in contact with the barrel of the horse (called also belly) and comprising a main structure, the main structure of the dorsal portion is made of a material whose elongation is greater than the elongation of the material of the main structure of the ventral portion. In this way, the dorsal portion may be optimally adapted to the morphology of the horse, limiting any discomfort while ensuring an effective support by the ventral portion, which is mechanically more tensile-resistant. In other words, it allows to ensure that the riding sheath stays in place without compromising its comfort.

In a preferred embodiment, the secondary member comprises a reinforced area having a Y-shape, so as to form a less extensible and more tensile-resistant area. This allows to ensure that the riding sheath is securely in place. This allows the saddle to be held effectively on the back of the horse. In other words, the addition of a reinforced area allows the secondary member to be connected to the main member in an effective way, while at the same time allowing a more flexible area to be formed around the shoulder tips, arms and neck of the horse, allowing to limit the pressure points on the horse and promoting its amplitude.

Preferably, the main member comprises a padded area configured to extend under the riding saddle so as to cushion the weight of the rider. Such a padded area allows to eliminate the need to add a cushioning between a pad of the prior art and the saddle, while ensuring the comfort of the horse.

In a preferred embodiment, the main member comprises at least one dorsal pocket configured to receive a wedging member for distributing the pressure points of the riding saddle on the body of the horse. This makes it quick and easy to adapt any type of saddle to a single riding sheath. The riding sheath may also be optimally adapted to the morphology of the horse.

Preferably, the main member comprises at least a first free attachment end and a second free attachment end configured to cooperate together to form a peripheral riding sheath. Advantageously, the main member is fitted to girdle the horse or removed simply and quickly.

Preferably, the first free attachment end and the second free attachment end are configured to cooperate in the manner of one of the following connections: press studs, zip closure, Molle system, loop through, adjustment loop, hook and loop textile connection of the hook and loop tape type, velvet and hook connection. This makes installation and removal of the main peripheral member quick and easy for the user. Such attachment systems also allow repeated mounting and removal without the risk of damaging the riding sheath.

In one embodiment, the riding sheath comprises at least one housing formed at least in part in a main structure of the dorsal portion and/or in a main structure of the ventral portion of the main member to allow the mounting of one or more electronic sensors. This allows to mount sensors as close as possible to the body of the horse to effectively measure various parameters relating to the life of the horse or of the strapping pressure, for example.

In one embodiment, the riding sheath comprises one or more sensors mounted around the circumference of the riding sheath (when girdling the horse) to monitor the strapping pressure. This allows to ensure an optimum strapping that ensure that the riding saddle is correctly positioned on the back of the horse, while at the same time avoiding too much pressure to prevent any risk of hindering the horse, particularly when it is moving. In the case of adjustable connecting members, the pressure sensors allow to ensure an optimum positioning of the riding sheath on the horse.

In one embodiment, the riding sheath comprises one or more sensors mounted in the dorsal portion of the main member, i.e. at the level of the back of the horse, to allow a measurement of an equivalent pressure on the back of the horse. This may be used, for example, to detect an imbalance of the rider or of the saddle or an asymmetry of the horse. Such faults may be corrected or compensated for to ensure an optimum ergonomics for both the horse and the rider.

In one embodiment, the riding sheath comprises one or more sensors mounted on the main member and/or on the secondary member to measure the heart activity of the horse, its temperature, its gait, etc.

The invention also relates to a method for placing a riding sheath as previously described to a horse, the method comprising the steps consisting in:
positioning the main member on the back of the horse,
girdling the horse with the main member so as to form the peripheral riding sheath, and
mechanically connecting the secondary member to the main member.

Preferably, the placing method comprises, after the step of attaching the secondary member to the main member, a step of adjusting the connecting members to adapt the riding sheath to the morphology of the horse.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of a plurality of riding accessories according to the prior art and a riding saddle placed on a horse.

FIG. 2 is a schematic representation of a riding sheath according to one embodiment of the invention placed on the body of a horse.

FIG. 3 is a schematic representation of a main member of the riding sheath of FIG. 2 in a flat view.

FIG. 4 is a schematic representation of the main member of FIG. 3, comprising a dorsal pocket for inserting cushioning members.

FIG. 5 is a schematic representation of a secondary member of the riding sheath of FIG. 2 placed on the body of a horse.

FIG. 6 is a schematic representation of the dimensions of an indentation formed in the main member of FIG. 3.

FIG. 7 is a schematic representation of an indentation formed in the secondary member of FIG. 4.

FIG. 8 is a diagram of the steps in a method for placing a riding sheath to a body of a horse according to one embodiment of the invention.

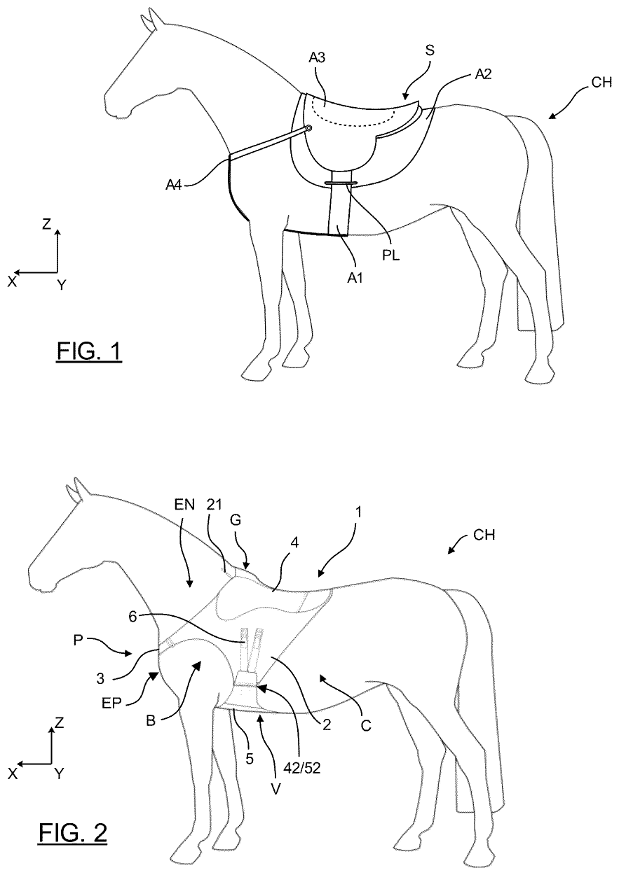

It should be noted that the figures set out the invention in detail in order to implement the invention, said figures of course being able to be used to better define the invention if necessary.

### DETAILED DESCRIPTION OF THE INVENTION

The following is a description of a riding sheath according to one embodiment of the invention, configured to be positioned on a horse.

In this example, with reference to FIG. 2, the riding sheath 1 is described in an orthogonal reference frame (X, Y, Z) defined in relation to a horse CH. In the reference frame (X, Y, Z), the riding sheath 1 extends longitudinally along an axis X, transversely along an axis Y and vertically along an axis Z. Also, the terms “front” and “rear” refer to the axis X which extends horizontally from the rear to the front of the horse CH, i.e. along the cranio-caudal axis of the horse CH. Similarly, the terms “under” and “over” (or “bottom” and “top”) refer to the horse CH and the axis Z, which extends vertically from bottom to top, as shown in FIG. 2.

FIG. 2 shows the riding sheath 1 positioned on the body C of a horse CH with a view to receive a riding saddle (not shown) so as to form a seat for a rider. To this end, the riding sheath 1 comprises a main member 2 configured to girdle the body C of the horse CH and a secondary member 3 configured to be positioned on the chest P of the horse CH. By the term “to girdle”, it is meant that the main member 2 extends peripherally around the body C of the horse CH, so as to cover both its back (on the spine) and the region of the body C located under its barrel directly behind the front legs and shoulders, referred to as the “girth passage”. Hereafter, for the sake of brevity, this region will be referred to as the “barrel” V.

FIG. 3 shows a flat view of the main member 2, i.e. substantially in the horizontal plane (X, Y).

In this example, the main member 2 comprises a dorsal portion 4 configured to be in contact with the back of the horse CH and a ventral portion 5 configured to be in contact with the barrel V of the horse CH (as shown in FIG. 2). More specifically, the dorsal portion 4 is configured to extend between the back of the horse CH and the saddle. In other words, the dorsal portion 4 fulfils the role of the prior art pad. The ventral portion 5 allows to eliminate the need for a prior art girth, as will be described in more detail later.

In one embodiment, as shown in FIG. 3, the main member 2 is made in one-part. In other words, the dorsal portion 4 and the ventral portion 5 are connected to form an integral assembly. In particular, in this example, with reference to FIG. 3, the dorsal portion 4 comprises a first end 41 connected in a fixed manner to a first end 51 of the ventral portion 5. In other words, the dorsal portion 4 is inseparable from the ventral portion 5.

Preferably, the dorsal portion 4 comprises a second free attachment end 42 configured to cooperate with a second free attachment end 52 of the ventral portion 5 to form the peripheral riding sheath 1. In other words, the second free attachment end 42 of the dorsal portion 4 and the second free attachment end 52 of the ventral portion 5 are configured to cooperate in a removable manner to allow the riding sheath 1 to be easily positioned and removed on the body C of the horse CH.

In this example, the two second free attachment ends 42, 52 are configured to be connected together by means of press studs, a zip closure, a hook-and-loop tape (e.g. Velcro® type), an eyelet attachment system (e.g. a “MOLLE” type attachment), an adjustment loop connection, a loop-through fastener or a velvet/hook connection. It goes without saying that the attachment system could be different.

In an alternative embodiment (not shown), the dorsal portion 4 and the ventral portion 5 may be separated. In other words, both the first end 41 and the second end 42 of the dorsal portion 4 are free, each being removably mechanically connected to the first end 51 and the second end 52 of the ventral portion 5 respectively. In this second embodiment, the first two attachment ends 41, 51 and the second free attachment ends 42, 52 are configured so as to be connected together respectively, for example, by means of press studs, a zip closure, a hook-and-loop tape (e.g. of the Velcro® type), an eyelet attachment system (e.g. a “MOLLE” type attachment), an adjustment loop connection, a loop through, or a velvet/hook connection. It goes without saying that the attachment system could be different.

When the riding sheath 1 is positioned on the body C of the horse CH, the first ends 41, 51 on the one hand, and the second free attachment ends 42, 52 on the other hand, extend, in this example, laterally substantially at the level of the two flanks of the horse CH. Alternatively, the first ends 41, 51 and the second free attachment ends 42, 52 may extend substantially under the ribs, on either side of the barrel V of the horse CH.

According to one aspect of the invention, the main member 2 comprises at least one extensible material, so as to adapt to the body C of the horse CH and thus avoid any discomfort. In other words, an extensible material allows the riding sheath 1 to adapt optimally to the morphology of the horse CH, ensuring its comfort.

Preferably, the extensible material is chosen from a fabric or a neoprene material.

In this example, the main member 2 comprises several webs of fabric, as will be described in more detail later. In this example, wherein the main member 2 is made in one-part, the dorsal portion 4 and the ventral portion 5 are connected at the level of their fixed ends 41, 51 by a seam to ensure a robust and homogeneous connection, free from pressure areas.

With reference to FIG. 3, the dorsal portion 4 comprises a main structure 43 which extends between the first end 41 and the second free attachment end 42. Preferably, the main structure 43 is symmetrical along the line of the back of the horse CH, which extends along the longitudinal axis X.

In this example, the main structure 43 of the dorsal portion 4 is made from a soft fabric, allowing it to adapt easily to the morphology of the horse CH and increase its comfort. In this example, the main structure 43 is made from Lycra®, which also provides a breathable fabric that effectively absorbs sweat of the horse CH. It goes without saying that the main structure 43 could alternatively be made from a different extensible material.

Preferably, the main structure 43 has a thickness (along the vertical axis Z in FIG. 3) of between 1 and 3 mm. The main structure 43 is therefore thinner than the prior art pads, which allows to limit discomfort to the horse while forming a lightweight riding sheath 1 that allows to limit heating of the horse CH.

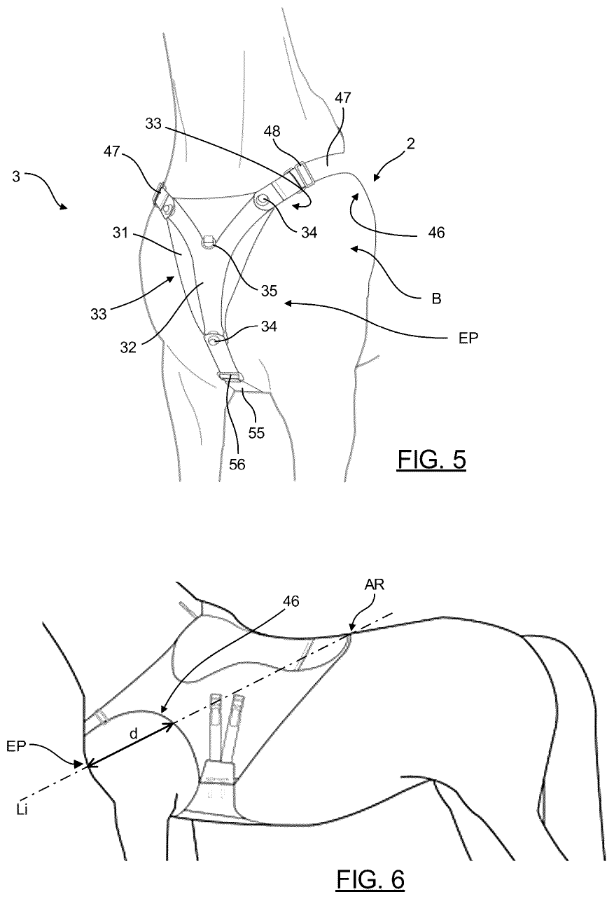

In a preferred embodiment shown in FIGS. 3 and 5, the main structure 43 comprises an indentation 46 configured to release the arm B from the horse CH. In this document, as shown in FIG. 3, the term “arm” refers to the humerus of the horse CH which extends above the front leg from the tip of the shoulder EP (also shown in the figures). Preferably, the indentation 46 is configured to release the tip of the shoulder EP, the biceps brachii and the triceps brachii of the horse CH. Preferably, the main structure 43 comprises two indentations 46, positioned symmetrically in relation to the line of the back of the horse CH, so as to release the tip of the shoulders EP, the biceps brachii and the triceps brachii on either side of the horse CH, allowing the latter to move freely. In this example, where the main structure 43 is made of fabric, each indentation 46 is easily cut and routed to contour the biceps brachii and the triceps brachii on either side of the horse CH.

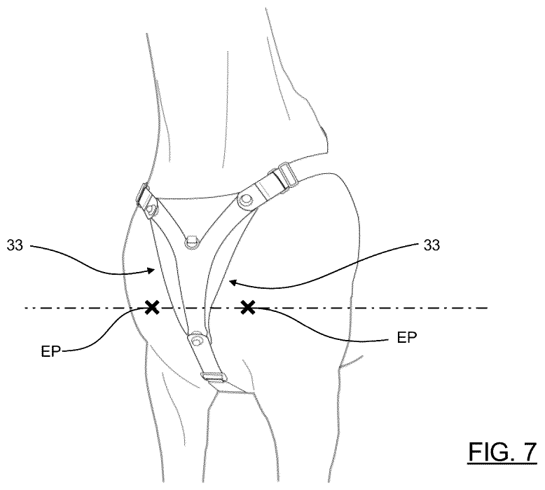

With reference to FIG. 6, in order to determine the dimensions of the indentation 46, a line Li is defined, which extends substantially between the tip of the shoulder EP and the rear end AR of the riding sheath 1 on the back of the horse CH. Preferably, the indentation 46 allows the arm B of the horse CH to be released by a distance d, measured from the tip of the shoulder EP along the line Li, greater than or equal to 20 cm. Preferably, the distance d is greater than or equal to 25 cm for a horse of average height at the withers. It goes without saying that this value may be different for a pony, for example.

Such a measurement may be made when the riding sheath 1 is positioned on the horse CH, for example using a tape measure. Thanks to this size, the indentation 46 allows to release in an optimum manner the arm B of the horse CH, and in particular its biceps brachii and its triceps brachii, allowing it to move with complete ease whatever its gait.

With reference to FIG. 3, the dorsal portion 4 comprises two connecting members 47 each configured to cooperate with the secondary member 3 so as to connect the main member 2 and the secondary member 3. The connecting members 47 allow a removable connection between the main member 2 and the secondary member 3 to position the riding sheath 1 optimally on the body of the horse CH, without hindering it. A removable connection between the main member 2 and the secondary member 3 also allows the riding sheath to be positioned quickly and easily on the horse CH. Preferably, the two connecting members 47 are each configured to extend forwards, on either side of the neck EN of the horse CH, to allow a symmetrical and balanced connection of the secondary member 3. It goes without saying that the dorsal portion 4 could alternatively comprise a different number of connecting members 47.

Preferably, each connecting member 47 is made from the material of the main structure 43, so as to limit the number of joints, which may represent an area of reduced mechanical strength. In this example, the main structure 43 and the connecting members 47 are cut from the same piece of fabric.

Preferably, each connecting member 47 has an elongated shape, extending from the main structure 43 to form the indentation 46 and prevent the riding sheath 1 from covering the arms B and the tips of the shoulders EP of the horse CH. The elongated shape of the riding sheath 1 also makes it easier to adapt to different horse morphologies.

In one embodiment, each connecting member 47 is adjustable, so as to precisely adapt the position of the secondary member 3 relative to the main member 2 on the horse CH. This allows to adapt the riding sheath 1 to different sizes and frames of horse. An adjustable connecting member 47 allows to form a universal riding sheath 1 that fits all horses.

Preferably, each connecting member 47 is in the form of an adjustable lanyard. By way of example, each connecting member 47 is similar to a pocket shoulder girth or an adjustable suspender lanyard. To this end, each connecting member 47 comprises, in this example, an adjustment device 48 for modifying the length of the connecting member 47 and adjusting it to the size of the horse CH. In this example, the adjustment device 48 is in the form of a metal buckle. It goes without saying that each connecting member 47 and each adjusting device 48 could take a different form.

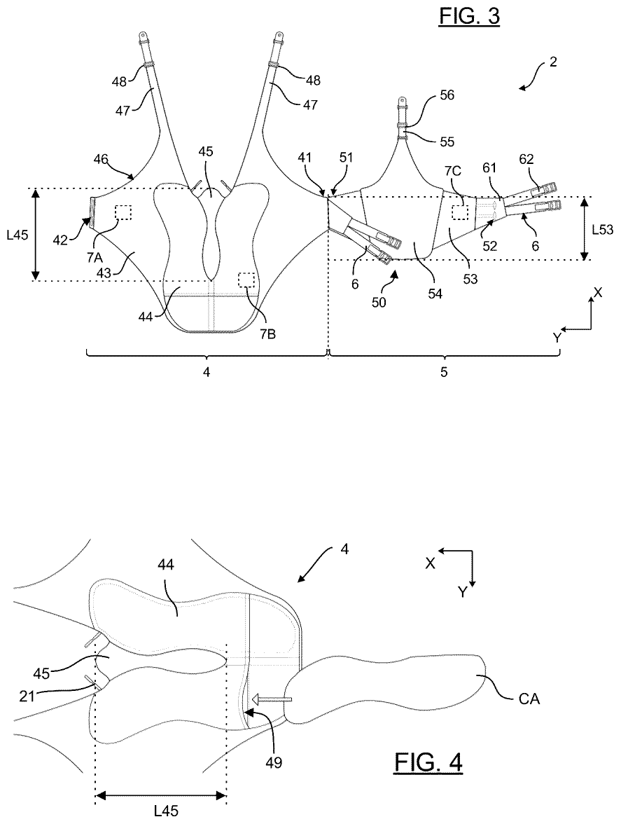

Preferably, with reference to FIG. 3 and FIG. 4, the dorsal portion 4 comprises a padded area 44. Preferably, the padded area 44 is integrated into the main member 2 and is configured to extend between the back of the horse CH and the saddle, so as to cushion the weight of the rider. In this example, the padded area 44 takes the form of a cushion integrated into the main member 2. This allows to eliminate the need to add a cushioning between the pad and the saddle, as was the case in the prior art. In this example, the padded area 44 comprises a yoke sewn onto the main structure 43 and into which a padding material is inserted. It goes without saying that the padded area 44 could alternatively be in a different form, for example in the form of a yoke made of a quilted fabric, foam, fleece or memory foam, or in the form of a pocket of air, water or silicone, etc.

Preferably, the padded area 44 has a perforated shape, so as to leave a central area 45 free at the level of the withers G of the horse CH. More specifically, the central area 45 is preferably made of soft fabric and has no padding. This allows to release the wither G, which must be free of any pressure to limit any risk of injury. In particular, in this example, the central area 45 is made of Lycra®. Thanks to the central area 45 of the riding sheath 1, it is no longer necessary to unclip the wither of the horse when fitting a pad, as was the case in the prior art. In this example, as shown in FIG. 4, the central area 45 has a length L45 along the longitudinal axis X of between 25×10⁻² and 35×10⁻² m. Such a length L45 allows to ensure that the assembly of the wither of the horse CH is covered only with a soft, extensible fabric, in this example of the Lycra® type.

According to a preferred aspect of the invention, with reference to FIG. 4, the dorsal portion 4 comprises one or more dorsal pockets 49 configured to receive a wedging member CA. The wedging member CA is configured to adapt the riding sheath 1 to the morphology of the horse CH and to different types of saddle. In particular, each wedging member CA allows to balance the saddle by adjusting it to the back of the horse CH. This means that whatever saddle is mounted to the back of the horse CH, the pressure points are optimally distributed over the back of the horse CH. Preferably, the dorsal portion 4 comprises two dorsal pockets 49 positioned symmetrically on either side of the line of the back of the horse CH, to allow the riding sheath 1 to be adapted optimally to the saddle and to the back of the horse CH. It goes without saying that the dorsal portion 4 could alternatively comprise a larger number of dorsal pockets 49, in particular more than two.

Preferably, each dorsal pocket 49 is formed by superimposing a layer of extensible material. In this example, each dorsal pocket 49 is formed by the addition of a web of fabric (for example an extensible fabric of the Lycra® type or a mesh fabric) attached to the main structure 43 of the dorsal portion 4, for example by a seam, in a similar way to a coat pocket for example.

Preferably, each wedging member CA is made of a flexible material to limit any risk of injury or discomfort for the horse CH. In one example, each wedging member CA is in the form of a foam, an assembly of foams or a mesh fabric. Alternatively, the wedging member CA could take the form of a deformable volume similar to the padded area 44 described above. The wedging member CA could be in the form of a silicone pocket or an air bag, for example. Each wedging member CA allows to ensure the comfort of both the horse CH and the rider.

An independent padded area 44 and a wedging member CA are shown, although the wedging member CA could just as easily be fitted on its own, for example as a replacement for the padded area 44 or as a complement to the padded area 44.

As described previously, the ventral portion 5 is configured to extend under the barrel V of the horse CH. To this end, with reference to FIG. 3, the ventral portion 5 comprises a main structure 53 which extends between the first end 51 and the second free attachment end 52. Preferably, the main structure 53 is substantially symmetrical along the barrel line V of the horse CH, which extends along the longitudinal axis X.

In this example, the main structure 53 of the ventral portion 5 is made of a material that is mechanically stronger than the material of the dorsal portion 4 to allow the riding sheath 1 to be held effectively on the body C of the horse CH. More specifically, the main structure 53 of the ventral portion 5 is preferably made from a material whose elongation is less than the elongation of the material of the main structure 43 of the dorsal portion 4.

According to a preferred aspect of the invention, the main structure 53 of the ventral portion 5 is made from a fabric web, allowing it to adapt to the morphology of the horse CH while being washable. Preferably, the ventral portion 5 is made from a synthetic fabric, for example nylon fiber, which is a fabric both waterproof and friction-resistant, and also protects the horse CH. In this example, the ventral portion 5 is made from a fabric such as Cordura®, which is advantageously light and highly resistant to abrasion. This means that even if the hooves of the horse CH rub against it regularly, for example, the riding sheath 1 has a long service life.

In this example, as shown in FIG. 3, the ventral portion 5 is in the form of a “bib girth” girth referred to the person skilled in the art. Advantageously, such a shape allows to provide both a ventral portion 5 whose dimensions are large enough to effectively protect the horse CH and small enough to avoid hindering it. In this respect, the main structure 53 of the ventral portion 5 preferably has a length L53 (shown in FIG. 3), defined in the plane (X, Y) along the lateral axis Y from the front of the first end 51 to the rear of the ventral portion 5, of between 35×10⁻² and 55×10⁻² m. Thanks to such a length, the rear of the flanks of the horse CH is advantageously not covered, which allows to free up the rib cage of the horse CH, while allowing the rider to have a direct contact with the horse CH, unlike the device of the prior art wherein the assembly of the flanks of the horse CH were covered.

In an alternative embodiment (not shown), the riding sheath 1 comprises two removable portions, connected for example to both the dorsal portion 4 and the ventral portion 5 of the main member 2 and configured to extend over the flanks of the horse CH, so as to protect it for example from spurs.

Preferably, the ventral portion 5 comprises a connecting member 55 configured to cooperate with the secondary member 3 so as to connect them. The connecting member 55 provides a removable connection between the main member 2 and the secondary member 3 to position the riding sheath 1 simply, quickly and optimally on the body of the horse CH, without hindering it. Preferably, the connecting member 55 is configured to extend under the barrel V of the horse CH, in particular under its chest P. It goes without saying that the ventral portion 5 could alternatively comprise a different number of connecting members 55.

Still referring to FIG. 3, the connecting member 55 preferably has an elongated shape from the main structure 53 to limit the areas of contact with the horse CH and thus avoid hindering it.

In one embodiment, the connecting member 55 of the ventral portion 5 is adjustable, so as to adapt the position of the secondary member 3 relative to the main member 2 on the horse CH, as will be described in more detail later. This allows to adapt the riding sheath 1 to different horse sizes and morphologies. Preferably, the connecting member 55 is in the form of an adjustable lanyard. In this example, the adjustable connecting member 55 comprises a metal buckle 56 to modify the length of the adjustable connecting member 55 and adjust it to the size of the horse CH. It goes without saying that the connecting member 55 could take a different form.

Preferably, the connecting member 55 of the ventral portion 5 is made from the same material as that used to make the main structure 53. In particular, the connecting member 55 is, in this example, made of nylon fibers, so as to effectively resist to the frictions and a high tensile stress. In this example, the connecting member 55 is connected to the main structure 53 by means of a connecting element, for example a metal loop. It goes without saying that the connecting member 55 could be connected to the main structure 53 in a different way, for example by means of a seam, a hook-and-loop attachment, a press stud, etc.

Preferably, still with reference to FIG. 3, the ventral portion 5 comprises a reinforced area 54 configured to extend directly under the barrel V of the horse CH, so as to protect it, for example, from being hit by a hoof or during jumping. Preferably, the reinforced area 54 is integrated into the main member 2. In this example, the reinforced area 54 comprises a fabric yoke sewn onto the main structure 53. Even more preferably, the reinforced area 54 comprises two superimposed yokes sewn onto the main structure 53, so that a different fabric may be attached to an inner face in contact with the horse CH and an opposite outer face. In this example, the inner face is made from a comfortable, breathable material. For example, the inner face is made from a quilted 3D mesh fabric. The outer surface is preferably made of a hard-wearing fabric, for example leather or nylon, so as to protect the barrel V of the horse CH effectively. In one embodiment, the reinforced area 54 also comprises a reinforcing member (not shown) to stiffen it and protect the barrel V of the horse CH. For example, the reinforcing member is in the form of a hull inserted between the yokes or in the form of a piece of leather.

In one embodiment, with reference to FIG. 3, the main member 2 comprises one or more housings 7 formed in the main structure 43 of the dorsal portion 4 and/or in the main structure 53 of the ventral portion 5, to allow one or more electronic sensors to be mounted. The sensors are mounted as close as possible to the body of the animal.

In a first embodiment, the riding sheath 1 comprises one or more sensors mounted around the circumference of the main member 2, when this is girdling the horse, to monitor the strapping pressure. To achieve this, the main member 2 comprises, in this example, a housing 7A wherein a pressure sensor is mounted. This allows to ensure that the riding sheath 1 is correctly attached to the body of the horse and that there is no risk of it moving. A pressure sensor also allows to ensure that there is no excessive pressure which could cause discomfort to the horse CH. Alternatively, the riding sheath 1 could comprise a plurality of housings 7A evenly distributed over the dorsal portion 4 and over the ventral portion 5 to control the strapping pressure on the periphery of the body of the horse CH.

In a second embodiment, the riding sheath 1 comprises one or more sensors mounted in the dorsal portion 4 of the main member 2 to allow a measurement of an equivalent pressure on the back of the horse. To achieve this, the main member 2 comprises, in this example, a housing 7B mounted substantially at the level of the back of the horse CH, wherein a pressure sensor is mounted. This may be used, for example, to detect an imbalance of the rider or of the saddle or an asymmetry of the horse. It goes without saying that the housing 7B could be positioned differently on the dorsal portion 4. Similarly, it goes without saying that the riding sheath 1 could alternatively comprise more than one housing 7B for mounting several pressure sensors, so as to ensure an equivalent and symmetrical pressure under the assembly of the riding saddle.

In a third embodiment, the riding sheath 1 comprises one or more sensors mounted on the main member 2 and/or on the secondary member 3 to measure the cardiac activity of the horse, its temperature, its gait, etc. For this purpose, in this example, the main member 2 comprises a housing 7C mounted on the ventral portion 5. It goes without saying that the housing 7C could be positioned differently on the riding sheath 1. Similarly, it goes without saying that the riding sheath 1 could alternatively comprise more than one housing 7C for mounting different sensors in the riding sheath 1 so as to measure each of the parameters independently.

In one embodiment, the main member 2 comprises two attachments 21 configured to be connected to a saddle. As shown in FIGS. 2 and 4, the attachments 21 are configured to extend on either side of the neck EN of the horse CH, so as to connect the saddle symmetrically and prevent the saddle from sliding back on the riding sheath 1 and freeing the withers G. Each attachment 21 is configured to be connected to a clamp or buckle on the saddle. In this example, each attachment 21 is in the form of a nylon lanyard comprising a hook-and-loop tape for easy opening and closing. Naturally, each attachment 21 could take a different form, for example a fabric loop, a press stud, etc.

As previously described and shown in FIG. 2, the secondary member 3 is independent of the main member 2 and is configured to be mounted on the chest P of the horse CH. The secondary member 3 is configured to hold the main member 2 in a predetermined position on the body C of the horse CH.

To this end, with reference to FIG. 5, the secondary member 3 has a shape adapted to extend over the chest P of the horse CH without hindering it. To this end, in this example, the secondary member 3 has a substantially triangular shape to release both the tip of the shoulders EP and the neck EN of the horse CH and to extend symmetrically over the horse CH. Alternatively, the secondary member 3 could be substantially Y-shaped.

The secondary member 3 preferably comprises a main structure 31 and two indentations 33 to release the shoulders EP of the horse CH so as to allow considerable freedom of movement.

Referring more specifically to FIG. 7, each indentation 33 allows each tip of shoulder EP of the horse CH to be fully released. In particular, the indentation 33 allows each biceps brachii of the horse CH to be fully released.

The combination of the indentation 46 in the main member 2 and the indentation 33 in the secondary member 3 allows the tip of the shoulder EP of the horse CH to be completely released, as well as these biceps brachii and triceps brachii, to guarantee a complete ease of movement for the horse CH.

According to a preferred aspect of the invention, the secondary member 3 comprises at least one extensible material, so as to adapt to the body C of the horse CH to avoid any discomfort and adapt the secondary member 3 to the morphology and locomotion of the horse CH. Preferably, the extensible material is chosen from a flexible fabric web or a neoprene material, which adapts to the movements of the horse CH. In this example, the main structure 31 is made of Lycra®, which provides an extensible fabric that adapts easily to the morphology of the horse, in particular around the shoulders EP and the neck EN of the horse CH, while providing a breathable fabric that effectively absorbs the sweat of the horse CH.

Preferably, the secondary member 3 comprises a reinforced area 32 so as to form a more tensile-resistant area for connecting the secondary member 3 to the main member 2. Preferably, as shown in FIG. 5, the reinforced area 32 comprises three branches to connect each connecting member 47, 55 respectively. In other words, the reinforced area 32 is Y-shaped in this example. This allows an effective connection without the risk of hindering the horse CH. A Y-shape allows both the shoulders EP and the neck EN of the horse CH to be released allowing an important movement freedom. Unlike the breast collar of the prior art, the secondary member 3 is advantageously shaped to limit the contact at the level of the shoulders EP of the horse. Alternatively, the reinforced area 32 could be triangular in shape, with each tip of the triangle corresponding to each branch of the Y described above.

In this example, the reinforced area 32 is also made of fabric so that it may be easily connected to the main structure 31, for example by means of a seam. In this example, the reinforced area 32 is made from a fabric with greater tensile resistance than the fabric used for the main structure 31. For example, the reinforced area 32 is made of nylon. Alternatively, the reinforced area 32 could be made from a different material. Such a reinforced area 32 allows the riding sheath 1 to be held in place effectively on the back of the horse CH. In other words, the main structure 31 made of extensible material combined with a reinforced area 32 allows to form a secondary member 3 that is sufficiently flexible around the shoulders EP and the neck EN to limit the pressure points and friction on the horse CH, while ensuring an effective and robust connection between the secondary member 3 and the main member 2.

To connect the main member 2 and the secondary member 3, the latter preferably comprises three connecting members 34 configured to cooperate with the three connecting members 47, 55 of the main member 2. Preferably, each connecting member 34 is mounted at one end of the reinforced area 32, so as to effectively resist the tensile stress generated by tightening the riding sheath 1 on the horse CH. In other words, each connecting member 34 is preferably mounted at one end of a branch of the Y-shape. The Y-shape also allows the connection between the main member 2 and the secondary member 3 to be positioned optimally to avoid any risk of the riding sheath 1 hindering the horse.

In a preferred embodiment, each connecting member 34 is in the form of a self-locking attachment which allows to eliminate the risk of unintentional opening, while allowing an easy manual opening by a user. In this example, each connecting member 34 is in the form of a LOXX® attachment. Even more preferably, in this example, such an attachment comprises a male part mounted on each connecting member 34 of the secondary member 3, and a female part, configured to cooperate with the male part and mounted on each attachment member 47, 55 of the dorsal portion 4 and of the ventral portion 5 of the main member 2. It goes without saying that each connecting member 34 could take a different form, for example a press stud, a belt buckle system, an eyelet closure, etc.

In this example, the secondary member 3 comprises an attachment device 35 preferably positioned in the middle of the reinforced area 32 and configured to connect an additional equipment, for example a fixed or ring martingale fork.

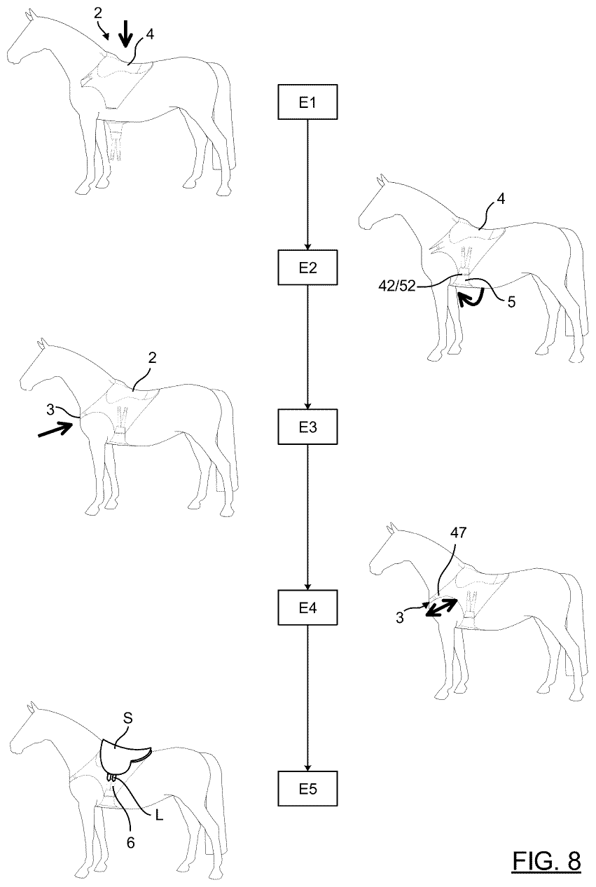

According to one aspect of the invention, the riding sheath 1 comprises at least one attachment member 6 configured to cooperate with a connecting member L (shown in FIG. 8) of a riding saddle S. allows the saddle to be attached to the riding sheath 1. Preferably, the riding sheath 1 comprises two attachment members 6, each configured to cooperate with two girth straps of the saddle to attach it to the riding sheath 1.

With reference to FIG. 3, each attachment member 6 is connected in a fixed manner to the main member 2. This allows to reduce the need for additional attachment member, for example. In this example, the two attachment members 6 are configured to extend on either side of the horse CH, substantially at the level of the flanks. In an alternative embodiment, the attachment members 6 extend substantially under the ribs, on either side of the barrel V of the horse CH, for example to allow a single-quarter saddle to be attached.

In this example, again with reference to FIGS. 2 and 3, each attachment member 6 is preferably mounted at the junction between the dorsal portion 3 and the ventral portion 4 of the main member 2. In particular, in this example, each attachment member 6 is preferably connected to the main member 2 by a seam to provide a one-part assembly. Alternatively, each attachment member 6 is mounted at the junction between the main structure 53 and the reinforced area 54 of the ventral portion 5 of the main member 2. This allows a single quarter saddle to be attached, for example.

Preferably, each attachment member 6 is in the form of a counter girth strap. Preferably, each attachment member 6 comprises two counter-girth straps for cooperating with two girth straps of a riding saddle, so as to attach the saddle reliably.

Preferably, each attachment member 6 is made from a robust material. For example, each attachment member 6 comprises a base 61 made of nylon fibers for simple connection to the main member 2. Alternatively, each attachment member 6 could be made of an elastic material. Each attachment member 6 also comprises an end 62, preferably made of leather to cooperate with a leather girth strap, as is known in the prior art. This makes attaching the saddle to the riding sheath 1 similar to attaching a saddle by means of girth straps and counter-girth straps, as was the case in the prior art, which is advantageous for a rider who may simply attach the saddle to the riding sheath 1 after fitting the horse with it.

The riding sheath according to the invention advantageously replaces three riding accessories: the pad, the girth and the breast collar, which saves a lot of time when preparing a horse. What's more, the riding sheath is fully machine-washable, unlike leather tack in the prior art. The two-piece riding sheath may be easily adapted to different morphologies and sizes of horse, allowing a precise positioning of both the secondary member and the main member on the horse. The three-in-one riding sheath is therefore semi-universal, offering a limited range of sizes, which facilitates the production chain, while still being adaptable to all sizes of horse.

When the riding sheath 1 comprises a padded area 44 that extends under the riding saddle to cushion the weight of the rider, this also replaces the cushioning, which is no longer needed, to form a semi-universal four-in-one riding sheath that easily adapts to different horse frames.

A method for placing a riding sheath 1 to a horse CH in accordance with one embodiment of the invention will now be described. In this example, the riding sheath 1 comprises a padded area 44 to cushion the weight of the rider and a wedge to adapt the saddle to the horse CH in the best possible way.

In a first step E1, a user positions the dorsal portion 4 of the main member 2 on the back of the horse CH. The main member 2 is preferably positioned so as to place the padded area 44 around the withers G of the horse CH and the central area 45 on the withers G, so as to ensure that the horse CH is not hindered.

Preferably, in a second step E2, the user then grips the ventral portion 5, which in this example is secured to the dorsal portion 4, and places it under the barrel V of the horse CH, like a girth of riding saddle. The second free attachment end 42 of the dorsal portion 4 and the second free attachment end 52 of the ventral portion 5 are then secured so as to girdle the horse CH with the main member 2. For example, the two second free attachment ends 42, 52, are connected by a zip closure, a hook-and-loop tape, a MOLLE-type attachment, a clip system, etc.

In a third step E3, the user positions the secondary member 3 on the chest P of the horse CH and connects it to the main member 2. In this step, the user attaches the three connecting members 47, 55 of the dorsal portion 4 and of the ventral portion 5 to the secondary member 3. In this example, the connection is made via the three connecting members 34 on the secondary member 3, which are mounted on the three arms of the Y-shape to provide a stable hold.

In this example, the three connecting members 47, 55 of the main member 2 are then adjusted in a step E4, so that the riding sheath 1 is precisely adapted to the morphology of the horse CH. The connecting members 47, 55 are connected securely while ensuring that no pressure points are applied to the body of the horse CH. The riding sheath 1 ensures the comfort of the horse CH.

In this example, the user then inserts two wedges CA into two dorsal pockets 49 of the main member 2, so as to adapt the shape of the saddle to the shape of the back of the horse CH. This allows to distribute the weight of the rider over the back of the horse CH and ensures an optimum comfort by balancing the saddle.

In step E5, the user then attaches the riding saddle S to the riding sheath 1. In this step, the attachment is achieved by means of two attachment members 6 mounted on either side of the horse CH at the level of the flanks and connected to two connecting members L of the riding saddle S. The attachment is thus made in a similar way to a riding girth of the prior art, which means that the habits of the rider do not change. The riding saddle S is securely attached to the riding sheath 1 and any risk of the riding saddle moving, for example, towards the rear of the body C of the horse CH is eliminated.

Thanks to the riding sheath, there's no need to use a pad, a girth, a breast collar or even a cushioning, while still ensuring the comfort and the safety of the horse.

1. A riding sheath, configured to be placed on a body of a horse, comprising:
a main member configured to girdle the body of the horse,
a secondary member, independent of the main member, configured to be positioned on chest of the horse, the secondary member being connected mechanically, in a removable manner, to the main member by at least one mechanical connecting member, the secondary member being configured to hold the main member in a predetermined position on the body of the horse, the main member and the secondary member each comprising at least one extensible material to adapt to the body of the horse, and
at least one attachment member configured to cooperate with a connecting member of a riding saddle so as to attach the riding saddle to the riding sheath, the attachment member being connected in a fixed manner to the main member.

2. The riding sheath according to claim 1, wherein the main member is made in one-part.

3. The riding sheath according to claim 1, wherein the connecting member is adjustable, so as to adapt the position of the secondary member relative to the main member on the horse.

4. The riding sheath according to claim 1, wherein the main member comprises at least one indentation to release an arm of the horse.

5. The riding sheath according to claim 1, wherein the secondary member comprises at least one indentation to release a tip of a shoulder of the horse.

6. The riding sheath according to claim 1, wherein the main member is made, at least in part, from at least one of a fabric web and neoprene.

7. The riding sheath according to claim 1, wherein the main member comprises a dorsal portion, configured to be in contact with a back of the horse and comprising a main structure of the main member, and a ventral portion, configured to be in contact with a barrel of the horse and comprising a main structure of the dorsal portion, and wherein the main structure of the dorsal portion is made of a material whose elongation is greater than an elongation of the material of the main structure of the ventral portion.

8. The riding sheath according to claim 1, wherein the secondary member comprises a reinforced area defining a Y-shape, so as to form a less extensible and more tensile-resistant area.

9. The riding sheath according to claim 1, wherein the main member comprises a padded area configured to extend under the riding saddle so as to cushion a weight of a rider upon the horse.

10. The riding sheath according to claim 1, wherein the main member comprises at least one dorsal pocket configured to receive a wedging member for distributing pressure points of the riding saddle on the body of the horse.

11. The riding sheath according to claim 1, wherein the main member comprises at least a first free attachment end and a second free attachment end configured to cooperate together to form a peripheral riding sheath.

12. The riding sheath according to claim 11, wherein the first free attachment end and the second free attachment end are configured to cooperate with a plurality of connections wherein the plurality of connections include press studs, a zip closure, a MOLLE system, loop through, adjustment loop, hook and loop textile connection of a hook and loop tape type, and a velvet and hook connection.

13. The riding sheath according to claim 1, further comprising at least one housing that is formed at least in part in a main structure of a dorsal portion and/or in a main structure of a ventral portion of the main member to allow mounting of one or more electronic sensors.

14. A method for placing the riding sheath according to claim 1 on the horse, the method comprising the steps in:
positioning the main member on a back of the horse,
girdling the horse with the main member so as to form a peripheral riding sheath, and
mechanically connecting the secondary member to the main member.

15. The placing method according to claim 14, wherein after the step of connecting the secondary member to the main member, a step of adjusting the connecting members to adapt the riding sheath to a morphology of the horse.
